(19) United States
(12) Patent Application Publication
(10) Pub. No.: US 2007/0179199 A1
(43) Pub. Date: Aug. 2, 2007

(54) Polyethylene glycol and production of the same

(76) Inventors: Torsten Henning, Schwerin (DE); Rainer Wagner, Burgkirchen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/582,726

(22) PCT Filed: Dec. 8, 2004
(86) PCT No.: PCT/EP04/13934

§ 371 Date: Nov. 29, 2006

(30) Foreign Application Priority Data
Dec. 12, 2003 (DE) 103 58 213.4

(51) Int. Cl. B01F 17/00

(52) U.S. Cl. 516/9

(57) ABSTRACT

Polyethylene glycol and preparation thereof.

Polyethylene glycol and preparation thereof

The invention relates to polyethylene glycols with a low aldehyde content and to a process for the preparation thereof.

Polyethylene glycols of the formula H(OCH₂CH₂)ₙOH with n equal to 4 to 900 corresponding to average molar masses of from 180 to 40 000, which are generally prepared by polymerizing ethylene oxide with water or mono-, di- or triethylene glycol, are employed in a large number of areas of application because of their interesting properties. A large number of these applications involve the polyethylene glycol making superficial contact with the skin of living creatures, especially humans, or being administered orally or parenterally to humans or animals. Examples of such applications are solvents for active ingredients, flavorings or fragrances in medicinal drops, solutions for injection, dietary supplements, tablets, ointments, sticks, suppositories or gelatin capsules; plasticizers for coatings of film-coated tablets; binders in tablets; humectants in toothpastes; moisturizers and/or conditioners in shower preparations, shampoos, cream rinses, hair treatments, soaps, liquid soaps, hair sprays, hair gels, after-shave products, face packs, sunscreen products, creams or lotions; ingredient of multiphase products such as two-phase shower preparations, two-phase foam baths or three-phase bath oils; and active ingredient in eye drops, laxatives or solutions having antiapoptotic activity.

It is important for these applications that the content of byproducts harmful for the living organism in these polyglycols is kept as low as possible. These byproducts include in particular aldehydes, especially formaldehyde.

For this reason, the “macrogols” monograph 07/2003:1444 in the European Pharmacopoeia (Ph. Eur.) 4.5 (valid since July 2003) requires a maximum aldehyde content, determined as formaldehyde in strongly acidic solution, of a maximum of 30 ppm, in particular applications of a maximum of 15 ppm, for use in pharmaceutical products.

However, polyethylene glycol commonly on the market frequently has an aldehyde content (determined as formaldehyde as specified in the Ph. Eur. “macrogols” monograph 07/2003:1444) which is distinctly, typically 40 to 100 ppm. This aldehyde content is brought about by the process for preparing polyethylene glycol. The procedure is normally such that firstly a mixture is prepared, by reacting water and ethylene oxide, which consists substantially of mono-, di-, triethylene glycol and higher glycols (glycol mixture). This glycol mixture is separated by distillation. Degradation reactions take place during this process, owing to the high temperature stress during the separation of the glycol mixture by distillation. The mono-, di- or triethylene glycol obtained in this way is then used as starting material for preparing the actual polyethylene glycol by addition of ethylene oxide, with basic catalysis, onto these glycols in a manner known per se.

The drying step at high temperatures of up to 150° C., which is frequently carried out before the ethoxylation to give polyethylene glycol, as described in EP 1 245 608, also further promotes the formation of aldehydes. These aldehydes are then found in the polyethylene glycols prepared by ethoxylation of the initial glycols.

Even polyethylene glycol prepared according to EP 1 245 608 by ethoxylation of triethylene glycol and having a low average molar mass of from 190 to 1050 shows an aldehyde content (determined as formaldehyde as specified in Ph. Eur. “macrogols” monograph 07/2003:1444) which is typically 40 to 100 ppm. The reason for this is presumably that the triethylene glycol employed in this case was also obtained with great temperature stress from the glycol mixture, as described above.

An aldehyde content above the desired limit of a maximum of 15 or 30 ppm (measured as formaldehyde) is unacceptable in many applications. The aldehyde content must be as low as possible especially in applications involving living people, such as, for example, cosmetic and pharmaceutical applications. The object is therefore to provide polyethylene glycols with a low aldehyde content.

It has now been found, surprisingly, that polyethylene glycol with a low aldehyde content can be prepared from monoethylene glycol, diethylene glycol or triethylene glycol if these glycols are obtained from the glycol mixture under substantially milder conditions.

The invention relates to a polyethylene glycol with a residual content of less than 30 ppm aldehyde, determined as formaldehyde and specified in the Ph. Eur. “macrogols” monograph 07/2003:1444. The polyethylene glycol preferably contains less than 15 ppm aldehyde determined as formaldehyde by said method. The polyethylene glycol preferably has an average molar mass of from 190 to 40 000, particularly preferably from 190 to 1050 and in particular from 190 to 210.

The polyethylene glycol of the invention is prepared in principle in the manner described above, which is known per se, namely preparation of a glycol mixture substantially consisting of mono-, di-, triethylene glycol and higher glycols, by reacting water and ethylene oxide, separation of this glycol mixture by distillation into the three said glycols and addition of ethylene oxide with basic catalysis onto the fractionated lower glycols. Essential for the invention in this connection are the physical parameters for the workup of the glycol mixture by distillation. Thus, the monoethylene glycol is to be obtained from the glycol mixture by distillation in vacuo (0 to 40 hPa) and 90 to 200° C., preferably at 5 to 20 hPa and 100 to 150° C., particularly preferably at 10 hPa and 120° C., diethylene glycol is to be obtained from the glycol mixture by distillation at 0 to 40 hPa and 100 to 220° C., preferably at 5 to 20 hPa and 10 to 180° C., particularly preferably at 10 hPa and 150° C., and triethylene glycol that is to be obtained from a glycol mixture by distillation at 0 to 40 hPa and 140 to 250° C., preferably at 5 to 10 hPa and 140 to 160° C., particularly preferably at 5 hPa and 140° C. Owing to this mild preparation, the respective initial glycol comprises a very low aldehyde content, and thus the polyethylene glycol resulting therefrom by subsequent ethoxylation likewise has a low aldehyde content. An additional possibility for reducing the aldehyde content consists of using as basic catalyst in the addition of ethylene oxide onto the mono-, di- or triethylene glycol dried alkali metal hydroxide or alkaline earth metal hydroxide, preferably dried sodium hydroxide. It is thus possible to dispense with the drying described in EP 1 245 608, in order to avoid thermal stress on the glycol and, associated therewith, aldehyde formation during the drying step. The polyethylene glycol resulting therefrom thus also has the desired low aldehyde content. However, it is not precluded in principle to combine the drying of the initial glycols by heating as described in EP 1 245 608 with the process of the invention.

The addition of ethylene oxide onto the mono-, di- or triethylene glycol takes place in a manner known per se, for example at 80 to 230° C., preferably 120 to 180° C. and a pressure of 0 to 1 MPa, preferably 0.2 to 0.6 MPa in the presence of a strongly alkaline substance such as NaOH or KOH in accordance with the statements in EP 1 245 608.

The following examples serve to explain the invention in more detail without, however, restricting it thereto. All percentage data are percentages by weight.

### EXAMPLE 1

### Preparation of Polyethylene Glycol with Average Molar Mass of 200

7491 kg of triethylene glycol which has been obtained by mild distillation at 5 hPa and 140° C. from a glycol mixture consisting substantially of mono-, di-, triethylene glycol and higher glycols, was mixed with 5 kg of 50% strength aqueous sodium hydroxide solution as catalyst and dried at 110° C. and vacuum for 1 hour. Then 2498 kg of gaseous ethylene oxide were added in a nitrogen atmosphere, and the reaction was stopped by neutralizing the catalyst with 6 kg of 90% strength lactic acid. The aldehyde content determined as formaldehyde as specified in Ph. Eur. “macrogols” monograph 07/2003:1444 was 13 ppm.

### EXAMPLE 2

### Preparation of Polyethylene Glycol with Average Molar Mass of 200

7491 kg of triethylene glycol which was obtained by mild distillation at 5 hPa and 140° C. from a glycol mixture consisting substantially of mono-, di-, triethylene glycol and higher glycols, and thereafter had a water content of 0.04%, were mixed with 2.5 kg of sodium hydroxide pellets as catalyst. Then 2498 kg of gaseous ethylene oxide were added in a nitrogen atmosphere, and the reaction was stopped by neutralizing the catalyst with 6 kg of 90% strength lactic acid.

The aldehyde content determined as formaldehyde as specified in Ph. Eur. “macrogols” monograph 07/2003:1444 was 13 ppm.

1. A process for preparing polyethylene glycol, comprising the steps of:
distilling a triethylene glycol from a glycol mixture consisting essentially of mono-, di-, triethylene glycol and higher glycols, at a pressure of from 5 to 10 hPa and a temperature of from 140 to 160° C.,
ethoxylating the triethylene glycol in the presence of a basic catalyst to form a polyethylene glycol.
wherein the polyethylene glycol has a residual content of less than 30 ppm aldehyde, determined as formaldehyde as specified by European Pharmacopoeia, “macrogols” monograph 07/2003:1441.

2. A process according to claim 1, wherein the polyethylene glycol has a residual content of less than 15 ppm aldehyde.

3. A process according to claim 1, wherein the polyethylene glycol has an average molar mass of from 190 to 40 000.

4. A process according to claim 1, wherein the polyethylene glycol has an average molar mass of from 190 to 210.

5. A process according to claim 1, wherein the triethylene glycol is obtained by distillation from a glycol mixture consisting essentially of mono-, di-, triethylene glycol and higher glycols, at a pressure of 5 hPa and a temperature of 140° C.

6. A process according to claim 1, wherein the basic catalyst is a dried alkali metal hydroxide or alkaline earth metal hydroxide.

7. A process according to claim 1, wherein the basic catalyst is dried sodium hydroxide.

8. A polyethylene glycol produced by a process in accordance with claim 1.

9. (canceled)

10. A cosmetic or pharmaceutical preparation comprising an active ingredient wherein the active ingredient is a polyethylene glycol as claimed in claim 8.

11. A cosmetic or pharmaceutical preparation comprising an auxiliary wherein the auxiliary is a polyethylene glycol as claimed in claim 8.
